(19) United States
(12) Patent Application Publication
(10) Pub. No.: US 2018/0074649 A1
(43) Pub. Date: Mar. 15, 2018

(54) INFORMATION PROCESSING APPARATUS, INFORMATION INPUT SYSTEM, INFORMATION PROCESSING METHOD, AND COMPUTER PROGRAM PRODUCT

(71) Applicant: Yohei KATOH, Kanagawa (JP)

(72) Inventor: Yohei KATOH, Kanagawa (JP)

(21) Appl. No.: 15/564,523

(22) PCT Filed: Apr. 5, 2016
(86) PCT No.: PCT/JP2016/001917

§ 371 Date: Oct. 5, 2017

(30) Foreign Application Priority Data
Apr. 8, 2015 (JP) 2015-079073

(51) Int. Cl. G06F 3/041; G06F 3/01; G06F 3/042

(52) U.S. Cl. CPC G06F 3/0418; G06F 3/042; G06F 3/017

(57) ABSTRACT

An information processing apparatus is configured to cause information input by contact of a contact object with a screen of a display apparatus to be displayed. The information processing apparatus includes: a calculating unit configured to calculate a feature amount of the contact object using output information output from a plurality of position detectors configured to detect a position where the contact object contacts the screen; an accumulating unit configured to accumulate at least one calculated feature amount; a tracking unit configured to track where the contact object contacts the screen based on the calculated feature amount and the at least one accumulated feature amount; and a control unit configured to control, when a determining unit determines not to receive input, input by contact of the contact object not to be received until the tracking unit finishes tracking where the contact object contacts the screen.

### TECHNICAL FIELD

The present invention relates to an information processing apparatus that causes information input by contact of a contact object with a screen of a display apparatus to be displayed on the display apparatus, an information input system that includes the information processing apparatus, an information processing method, and a computer program product for causing a computer to execute the method.

### BACKGROUND ART

There is an electronic blackboard as an apparatus that receives information handwritten by a user in real time and displays the information. When a user performs handwriting on the electronic blackboard, if a hand or a sleeve touches a screen, unintended drawing may occur, and malfunction of gesture operations such as enlargement, reduction, and scroll may occur.

In view of the foregoing, a technique is developed that regards, when contact (touch) with a screen occurs in an area equal to or larger than a predetermined size, the contact as contact of a palm or an elbow and invalidates the detected position (for example, see Patent Literature 1).

### SUMMARY OF INVENTION

### Technical Problem

In the above-mentioned technique, after a lapse of a predetermined time from the contact, the contact is regarded as contact of a palm or an elbow and is invalidated. If a palm or an elbow is released from the screen at a lapse of the predetermined time, contact in an area smaller than a predetermined size may be detected. The contact is regarded as contact of a pen or a finger, disadvantageously causing malfunction of gesture operations such as enlargement, reduction, and scroll, or disadvantageously causing occurrence of unintended drawing.

The present invention has an object to provide an apparatus and the like capable of reducing occurrence of unintended drawing and malfunction of gesture operations.

### Solution to Problem

According to one aspect of the present invention, an information processing apparatus is configured to cause information input by contact of a contact object with a screen of a display apparatus to be displayed on the display apparatus. The information processing apparatus includes a calculating unit, an accumulating unit, a tracking unit, a determining unit, and a control unit. The calculating unit is configured to calculate a feature amount representing a feature of the contact object using output information output from a plurality of position detectors configured to detect a position where the contact object contacts the screen. The accumulating unit is configured to accumulate at least one feature amount calculated by the calculating unit. The tracking unit is configured to track where the contact object contacts the screen based on the feature amount calculated by the calculating unit and the at least one feature amount accumulated in the accumulating unit. The determining unit is configured to determine whether to receive input by contact of the contact object based on the feature amount calculated by the calculating unit and the at least one feature amount accumulated in the accumulating unit. The control unit configured to control, when the determining unit determines not to receive input, input by contact of the contact object not to be received until the tracking unit finishes tracking where the contact object contacts the screen.

### Advantageous Effects of Invention

According to the present invention, occurrence of unintended drawing and malfunction of gesture operations can be reduced.

### BRIEF DESCRIPTION OF DRAWINGS

FIG. 1 is a view illustrating a configuration example of an information input system according to embodiments.

FIG. 2 is a diagram illustrating a hardware configuration of an information processing apparatus included in the information input system.

FIG. 3 is a functional block diagram illustrating the information processing apparatus according to a first embodiment.

FIG. 4 is a functional block diagram illustrating the information processing apparatus according to a second embodiment.

FIG. 5 is a flowchart illustrating a flow of input control performed by the information processing apparatus.

FIG. 6 is a flowchart illustrating a flow of finger input processing.

FIG. 7 is a view illustrating the size of a palm when the palm touches a display screen.

FIG. 8 is a view illustrating an example of a light-blocking image.

FIG. 9 is a flowchart illustrating a flow of processing for determining a hand-touching state.

### DESCRIPTION OF EMBODIMENTS

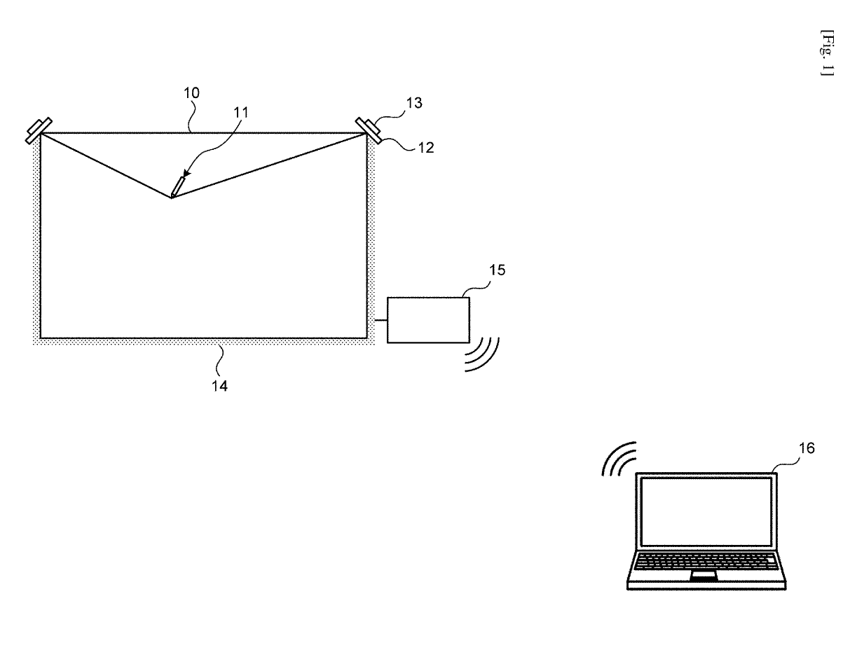

FIG. 1 is a view illustrating a configuration example of an information input system according to embodiments. The information input system includes a display apparatus 10, a plurality of position detectors, and an information processing apparatus. The display apparatus 10 is an apparatus such as a display including a screen on which information is displayed. The display may be a cathode ray tube (CRT) display, a liquid crystal display, or a plasma display.

The position detectors detect a position where a contact object 11 contacts the screen of the display apparatus 10 in order to input information. For this reason, the position detectors include, for example, at least two input devices 12. The information input system can include a light-blocking lighting 13 as a lighting device that irradiates the contact object 11 with light and a retroreflection plate 14 in order to detect the position. Hereinafter, explanation is provided on a configuration where two input devices 12 and two light-blocking lightings 13 are included.

The input devices 12 include light-receiving elements that receive light. For example, the input devices 12 and the light-blocking lightings 13 are disposed at two upper corners of a rectangular screen, and the light-blocking lightings 13 irradiate the contact object 11 with light approximately parallel to the screen. The retroreflection plate 14 is disposed so as to surround at least three sides of the screen to which the two input devices 12 are directed, and reflects light emitted by the light-blocking lightings 13 so as to return the light to the same light-blocking lightings 13.

Because the light-blocking lightings 13 and the input devices 12 are disposed at the same position, reflected light enters the input devices 12 and the input devices 12 receive the reflected light. The input devices 12 photoelectrically convert the received reflected light, apply analog/digital conversion to the photoelectrically converted light, and output an image as output information. When the contact object 11 is absent on the screen, an object that blocks light is absent, and the input devices 12 output an image where the part of the retroreflection plate 14 is continuously white. By contrast, when the contact object 11, such as a pen and a finger, contacting the screen is present on the screen, the contact object 11 blocks light, and the input devices 12 output an image where the part of the retroreflection plate 14 is interrupted in the middle. These images are output from each of the two input devices 12, and are transmitted to the information processing apparatus. The information processing apparatus performs processing such as calculation of a coordinate position on the screen, drawing, and display on the display apparatus 10 based on these images.

The light-blocking lightings 13 are used depending on the type of the contact object 11. The light-blocking lightings 13 are turned on when the contact object 11 is non-light-emitting object such as a finger, and is turned off when the contact object 11 is a light-emitting pen that emits light.

The information processing apparatus includes a controller 15 that receives output information from the input devices 12 and performs processing such as calculation of a coordinate position on the screen from the output information. The information processing apparatus also includes a personal computer (PC) 16 that performs processing (pen input processing) for drawing information that a user has written with a pen on the screen and displaying the drawing on the screen. The PC 16 also performs processing such as enlargement, reduction, and scroll of information displayed corresponding to gesture operations of a user. In FIG. 1, the controller 15 and the PC 16 are configured to exchange information through wireless communication, but the configuration is not limited to the configuration. The controller 15 and the PC 16 may be coupled to each other by a cable and the like, and may be coupled to each other through a network. The information processing apparatus is not limited to the one formed of two apparatuses as described above, and may be formed of one apparatus or three or more apparatuses.

When a user inputs information with a pen, and a palm, an elbow, or the like contact the screen together with the pen, the input devices 12 detect the contact of the palm, the elbow, or the like. Then, drawing is performed also at a part where a palm, an elbow, or the like contacts the screen, and information that has already been drawn on the part may be overwritten with the drawing. Movement of a palm, an elbow, or the like may cause enlargement, reduction, or scroll of the screen. Such contact causes erroneous drawing and malfunction. Thus, when a contact object is a palm, an elbow, or the like, it is required that control be performed so as not to receive information input by the contact.

The information processing apparatus determines what the contact object 11 is, and controls, when the contact object 11 is not a pen or a finger but is a palm, an elbow, or the like, information input by the contact of the palm, the elbow, or the like not to be received. In this manner, occurrence of erroneous drawing and malfunction can be reduced. The following describes a configuration for implementing the foregoing and processing executed by the configuration in detail.

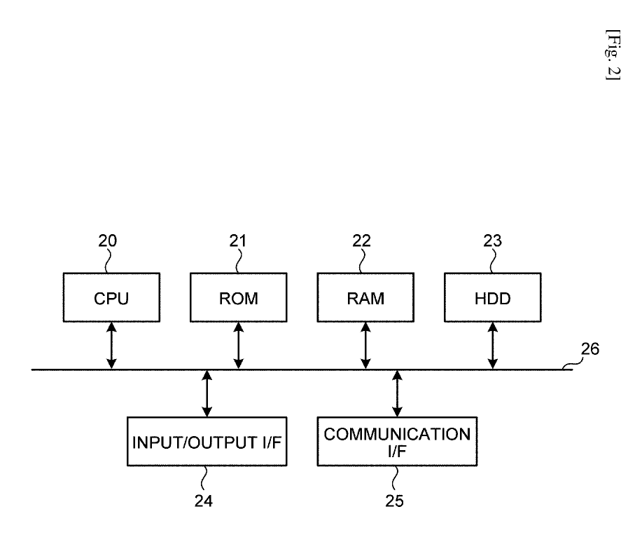

FIG. 2 is a diagram illustrating a hardware configuration of the information processing apparatus. The information processing apparatus includes a central processing unit (CPU) 20, a read only memory (ROM) 21, a random access memory (RAM) 22, a hard disk drive (HDD) 23, an input/output interface (I/F) 24, and a communication interface (I/F) 25 as hardware. The CPU 20, the ROM 21, the RAM 22, the HDD 23, the input/output I/F 24, and the communication I/F 25 are each coupled to a bus 26, and exchange information and the like through the bus 26.

The CPU 20 is a computing means and controls operation of the whole apparatus. The ROM 21 is a read-only non-volatile memory, and stores computer programs such as a boot program for booting the information processing apparatus and firmware. The RAM 22 is a volatile memory capable of rapidly reading and writing information, and provides a working area when the CPU 20 performs information processing. The HDD 23 is a non-volatile storage medium capable of reading and writing information, and stores an operating system (OS) and various types of application programs, a computer program for performing the above-mentioned processing, a configuration file, and the like.

The input/output I/F 24 is coupled to the bus 26 and various types of hardware, for example, the display apparatus 10 and the position detectors, and controls the hardware. The communication I/F 25 is coupled to other apparatuses through wireless communication, and controls communication between the information processing apparatus and other apparatuses.

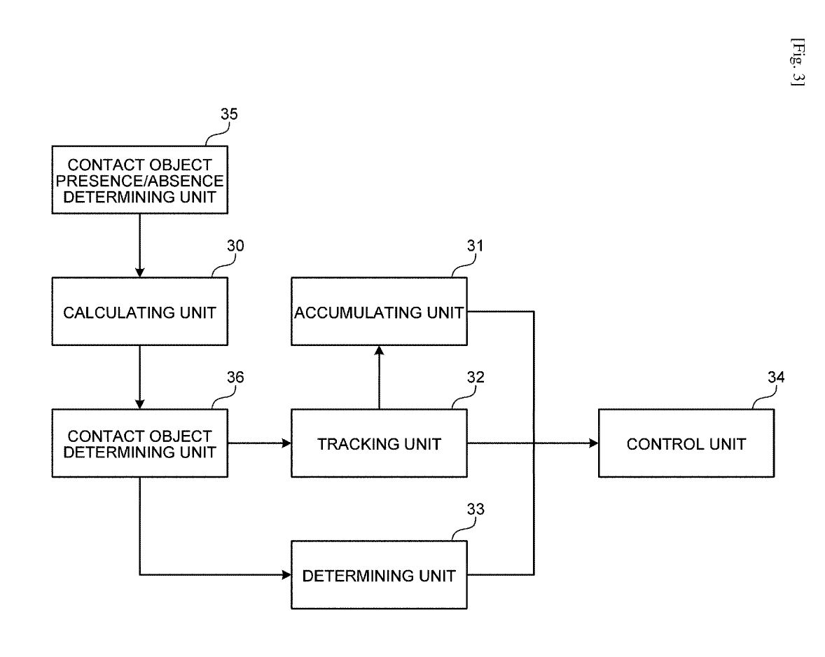

FIG. 3 is a functional block diagram illustrating the information processing apparatus according to a first embodiment. The information processing apparatus includes at least a calculating unit 30, an accumulating unit 31, a tracking unit 32, a determining unit 33, and a control unit 34. In the embodiment illustrated in FIG. 3, the information processing apparatus also includes a contact object presence/absence determining unit 35 and a contact object determining unit 36. The CPU 20 executes the above-mentioned computer program so as to implement these function units.

Output information output from the input devices 12 is transmitted to the contact object presence/absence determining unit 35. The contact object presence/absence determining unit 35 determines whether the contact object 11 is present based on the output information. When detecting no position of the contact object 11, the input devices 12 output, for example, the above-mentioned image where the part of the retroreflection plate 14 is continuously white as output information. When detecting a position of the contact object 11, the input devices 12 output an image where the part of the retroreflection plate 14 is interrupted in the middle as output information. The contact object presence/absence determining unit 35 can determine whether the contact object 11 is present based on whether the retroreflection plate 14 that is continuously white is interrupted in the middle in the output image.

When determining that the contact object 11 is present, the contact object presence/absence determining unit 35 transmits the output information to the calculating unit 30. The calculating unit 30 calculates a feature amount representing a feature of the contact object 11 using the output information. Examples of the feature amount include a coordinate position on the screen where the contact object 11 contacts the screen, the magnitude (size) of a contacting part, the number of contacting parts, occurrence of blocking related to the contact, a contact state, and a contacting time (detecting time). The calculating unit 30 calculates a feature amount and transmits the calculated feature amount to the contact object determining unit 36.

A coordinate position can be calculated from, for example, output information by triangulation. Specifically, a coordinate position can be calculated by defining the distance between the input device 12 and the other input device 12, that is, a straight line connecting the input device 12 to the other input device 12 as a reference line, and using an angle formed between the reference line and a straight line connecting each of the two input devices 12 to the contact object 11. The formed angle can be obtained as an angle formed by a reference line and a straight line connecting a central coordinate of each of the input devices 12 and a central coordinate of the contact object 11. The size can be calculated using output information and the calculated coordinate position. A calculating method will be described in detail later.

The number of contacting parts and whether blocking occurs can be determined from the number of interrupted parts in output information. When the numbers of interrupted parts in output information output from the respective input devices 12 are the same, no contact object is hidden behind another contact object. Thus, the number is determined as the number of parts contacting the screen, and it can be determined that blocking does not occur. By contrast, when the both are different from each other, a contact object is considered to be hidden behind another contact object. Thus, the larger number is determined as the number of parts contacting the screen, and it can be determined that blocking occurs.

Examples of a contact state include states such as a contact start, during contact, and a contact end. A contact state can be determined from output information periodically output from the input devices 12. Specifically, it can be determined that the time when the contact object 11 is initially detected is defined as a contact start, the time when contact is detected for the second time or after is defined as during contact, and the time when contact of the contact object 11 ends is defined as a contact end. The time when contact ends means the time when the contact object 11 contacting the screen is released from the screen.

The contact object determining unit 36 determines the type of the contact object 11 based on the calculated feature amount. Whether the type is a pen, a finger, a palm, or an elbow can be determined from, for example, the size of the contact object 11. The area may be used, and the longitudinal length, the lateral width, or the like may also be used as the size. The contact object determining unit 36 transmits the determined result to the tracking unit 32 and the determining unit 33. When a light-emitting pen is used, whether the type is a pen or a finger can be determined by presence/absence of light emission from the pen, and when a wireless signal is transmitted at the time of the contact of a pen, the type can be determined by presence/absence of the wireless signal. When the contact object 11 has both functions, the type can be determined by the both.

The tracking unit 32 identifies the contact object 11 based on the result determined by the contact object determining unit 36, and starts tracking where the contact object 11 contacts the screen. When the contact object 11 initially contacts the screen, the tracking unit 32 assigns identification information (contact identification (ID)) for identifying the contact object 11. The tracking unit 32 accumulates the feature amount of the contact object 11 and a contact ID in the accumulating unit 31 in association with each other. The accumulating unit 31 can accumulate the feature amounts arranged in a time series manner for every contact ID.

When assigning a contact ID, the tracking unit 32 refers to the feature amounts accumulated in the accumulating unit 31, and determines, if the contact object 11 is in a certain distance from a previous coordinate position and the change in size is in a certain range, that the contact object 11 is the same and assigns the same contact ID. By contrast, if the contact object 11 is out of the certain distance and the change in size is out of the certain range, the tracking unit 32 assigns a new contact ID. In this manner, the tracking unit 32 assigns a contact ID so as to identify and track the contact object 11. The tracking unit 32 can track the contact object 11 until the contact object 11 is released from the screen.

The determining unit 33 determines whether to receive input by contact of the contact object 11 based on the result determined by the contact object determining unit 36 and information on the feature amount accumulated in the accumulating unit 31. The determining unit 33 can determine to receive input when the contact object 11 is a pen or a finger, and not to receive input when the contact object 11 is a palm or an elbow. When the contact object 11 is a palm or an elbow, a so-called hand-touching state is determined, and the determining unit 33 determines whether the hand-touching state occurs, and can determine not to receive input when the hand-touching state occurs.

When the determining unit 33 determines not to receive input, in other words, determines that the hand-touching state occurs, the control unit 34 controls input by contact of the contact object 11 not to be received until the tracking unit 32 finishes tracking where the contact object 11 contacts the screen. Specifically, the control unit 34 instructs the PC 16 that performs drawing processing, to ignore input by contact of the contact object 11.

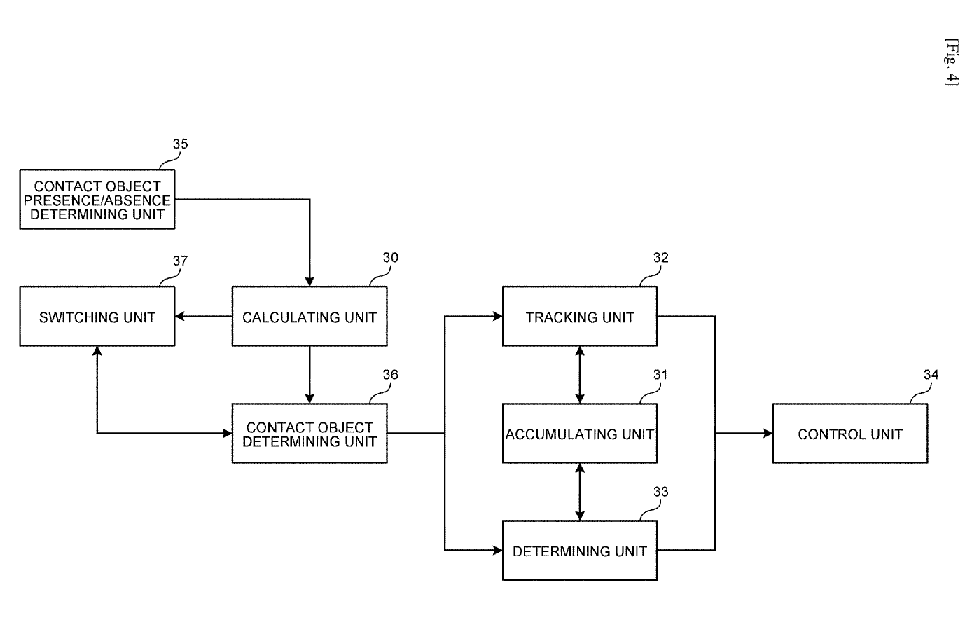

The embodiment illustrated in FIG. 3 has the configuration where determination is made as to whether the contact object 11 is a pen or a finger by, for example, presence/absence of a contact signal transmitted at the time of the contact of a pen. If only one determining method like this is used for making determination, erroneous detection of a contact signal may cause erroneous determination. In order to reduce such erroneous detection, the configuration illustrated in FIG. 4 can be adopted for making determination with two determining methods. Similarly to the apparatus illustrated in FIG. 3, the information processing apparatus illustrated in FIG. 4 includes the calculating unit 30, the accumulating unit 31, the tracking unit 32, the determining unit 33, the control unit 34, the contact object presence/absence determining unit 35, and the contact object determining unit 36, and further includes a switching unit 37.

The calculating unit 30 and others have already been described above, and only the switching unit 37 is described here. The embodiment illustrated in FIG. 4 has a configuration where the information input system has a plurality of input detection methods and the switching unit 37 switches between these input detection methods. Examples of the input detection methods include a pen input method using light emission from a pen and a finger input method using light blocking with a finger or the like. The switching unit 37 switches from the pen input method to the finger input method to identify a finger or the like, and switches to the opposite method to allow a pen to be identified. The switching between these methods can be implemented by turning on and off the light-blocking lightings 13 illustrated in FIG. 1.

The switching unit 37 sets the finger input method in an initial state, and, after a feature amount has been calculated by the finger input method, switches to the pen input method without making any determination. The contact object determining unit 36 determines whether the contact object 11 is a pen. Because the feature amount has been calculated by the finger input method, the contact object determining unit 36 determines the contact object 11 from the feature amount. Subsequently, because the method has been switched to the pen input method, the contact object determining unit 36 can determine whether the contact object 11 is a pen from presence/absence of light emission. In this manner, determination is made by two methods so as to reduce erroneous detection of contact and gesture operations. If the contact object 11 is a pen, the processing can be performed continuously, and pen input processing can be executed without delay. If the contact object 11 is not a pen, the contact object 11 is something other than a pen, and the switching unit 37 switches to the finger input method.

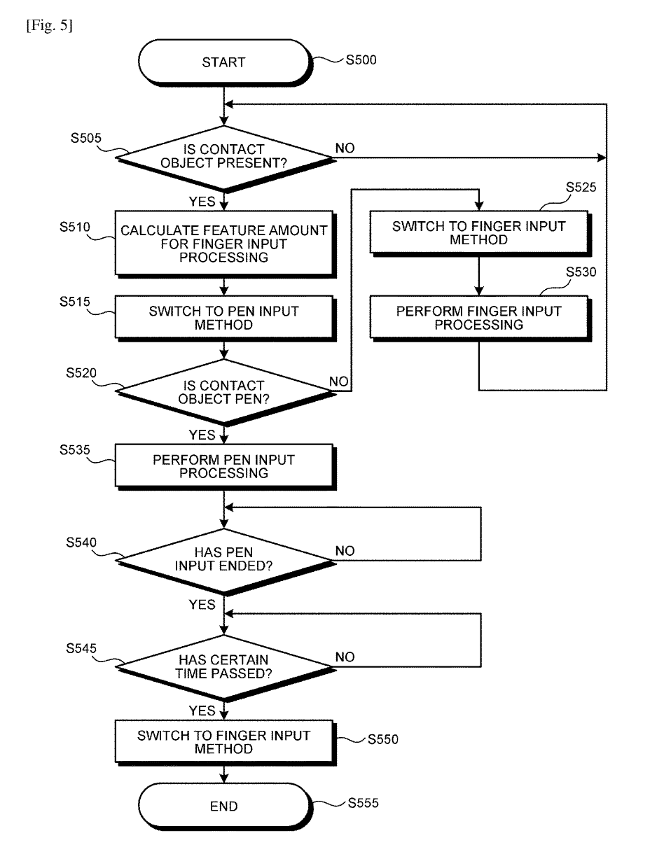

The following describes the processing executed by the information processing apparatus with reference to FIG. 5. The flow illustrated in FIG. 5 illustrates processing contents of the information processing apparatus in the information input system that has a plurality of input detection methods. This processing starts from Step 500, and at Step 505, the contact object presence/absence determining unit 35 determines presence/absence of the contact object 11 contacting the screen from output information output from the input devices 12. This determination is repeatedly made until the contact object 11 is detected.

When the contact object 11 is detected, the calculating unit 30 detects a shadow area of the contact object 11 from an image as output information output from the input devices 12, and calculates a feature amount from the information on the area at Step 510. The shadow area is a part where the retroreflection plate 14 that is continuously white is interrupted in the middle in the image described above. Examples of the feature amount include the above-mentioned coordinate position, the number, the size, and a detecting time. In this example, the switching unit 37 switches to the pen input method without determining what the contact object 11 is at Step 515. In this manner, switching between the methods without making any determination enables the pen input processing after switching to be performed without delay. In the embodiment, the method is switched to the pen input method, but the method may be switched to the finger input method so as to perform finger input processing after switching without delay. When the method is switched to the pen input method, the light-blocking lightings 13 can be turned off.

The contact object determining unit 36 determines whether the contact object 11 is a pen at Step 520. If the contact object 11 is a pen, the process goes to Step 535, and, if the contact object 11 is something other than a pen, the process goes to Step 525. The input detection method is switched to the finger input method at Step 525 because the contact object 11 is a finger, a palm, an elbow, a sleeve, or the like other than a pen. The finger input processing is performed at Step 530, and the process goes back to Step 505 again.

In the switching to the finger input method at Step 525, the light-blocking lightings 13 are turned on and the contact object 11 is made detectable by light, and at Step 530, finger input processing is performed using the feature amount calculated at Step 510. The finger input processing will be described in detail later.

The PC 16 performs pen input processing at Step 535. The pen input processing is performed by the PC 16 based on information input not by a finger but by a pen. Examples of the pen input processing include drawing on a screen, enlargement and reduction of display, and scroll of the screen. Whether the pen input processing has ended is determined at Step 540. Whether the pen input processing has ended can be determined by whether a pen is released from the screen and the tracking unit 32 has finished the tracking. This determination is repeatedly made until the pen input processing ends.

Whether a certain time has passed after the pen input processing ended is determined at Step 545. This processing is repeatedly performed until a certain time passes. The switching unit 37 switches the input detection method from the pen input method to the finger input method at Step 550. At this time, the light-blocking lightings 13 are turned on and the contact object 11 is made detectable by light blocking. After the method is switched in this manner, the process goes to Step 555 and this processing ends. When next processing is performed, the method can be switched from the finger input method to the pen input method at Step 515.

FIG. 5 illustrates a flow of the whole processing, but the following describes the finger input processing at Step 530 in FIG. 5 in detail with reference to FIG. 6. This processing starts from Step 600, and the calculating unit 30 calculates a coordinate position, the size, the number, occurrence of blocking, a contact state, a detecting time, and/or the like of the contact object 11 contacting the screen as a feature amount at Step 605. The tracking unit 32 assigns a contact ID, and starts tracking the contact object 11. The tracking unit 32 stores and accumulates the feature amount in the accumulating unit 31 at Step 610.

It is determined whether the contact object 11 of a determination object for which the determining unit 33 is to determine whether the hand-touching state occurs is released from the screen at Step 615. When it is determined that the contact object 11 is released from the screen, the process goes to Step 620 and touch processing, in other words, drawing or the like by contact of a finger is performed, and this processing ends at Step 635.

When it is determined that the contact object 11 is not released from the screen at Step 615, the process goes to Step 625, and whether the hand-touching state occurs is determined. Determination of the hand-touching state will be described in detail later. When it is determined that the hand-touching state does not occur at Step 625, the process goes to Step 620 and touch processing is performed. By contrast, when it is determined that the hand-touching state occurs, the process goes to Step 630 and touch cancellation processing is performed. In the touch cancellation processing, a gesture operation or drawing by contact is not performed, and, if drawing by contact has been performed, drawing contents are erased using the feature amount accumulated in the accumulating unit 31. In this manner, erroneous drawing caused by hand-touching can be canceled and can be avoided. After the touch cancellation processing ends, the process goes to Step 635 and this processing ends.

In this manner, the control unit 34 can control drawing not to be performed for the contact object 11 for which occurrence of the hand-touching state is determined, and can control earlier drawing of the contact object 11 to be canceled.

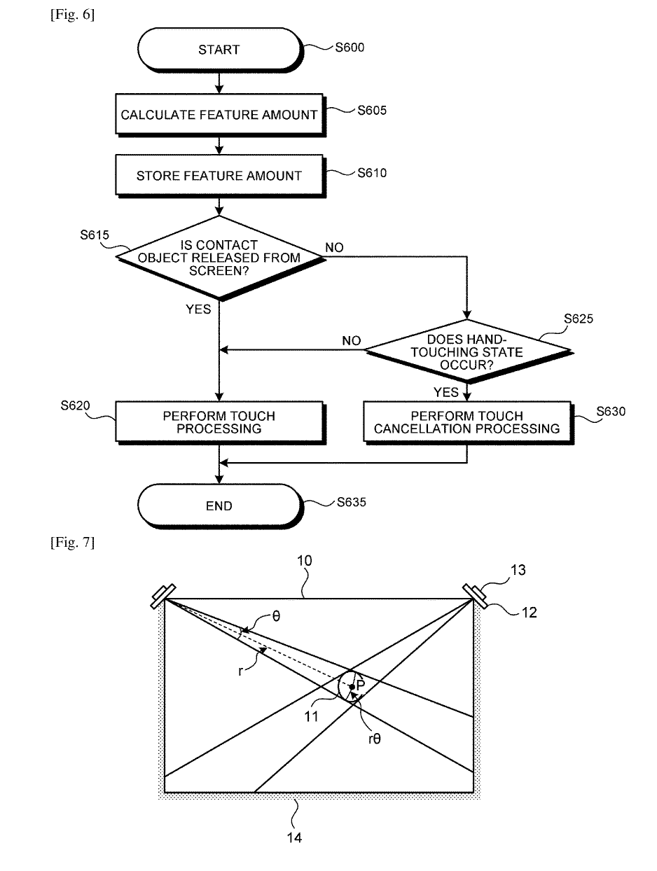

The following describes an example of calculating the size of a palm when the palm touches the screen with reference to FIG. 7. In FIG. 7, θ represents an angle formed by two tangent lines that are drawn from each of the input devices 12 to the contact object 11 to be detected, which is a palm illustrated as an ellipse in FIG. 7, and r represents the distance from each of the input devices 12 to a touch coordinate P of the center of a palm calculated by triangulation. The size of a palm to be detected can be calculated as a lateral width of the palm, and the lateral width can be calculated using θ and r. Specifically, the lateral width is defined to be almost equal to an arc length of a circle with the center at each of the input devices 12, and can be calculated as rθ.

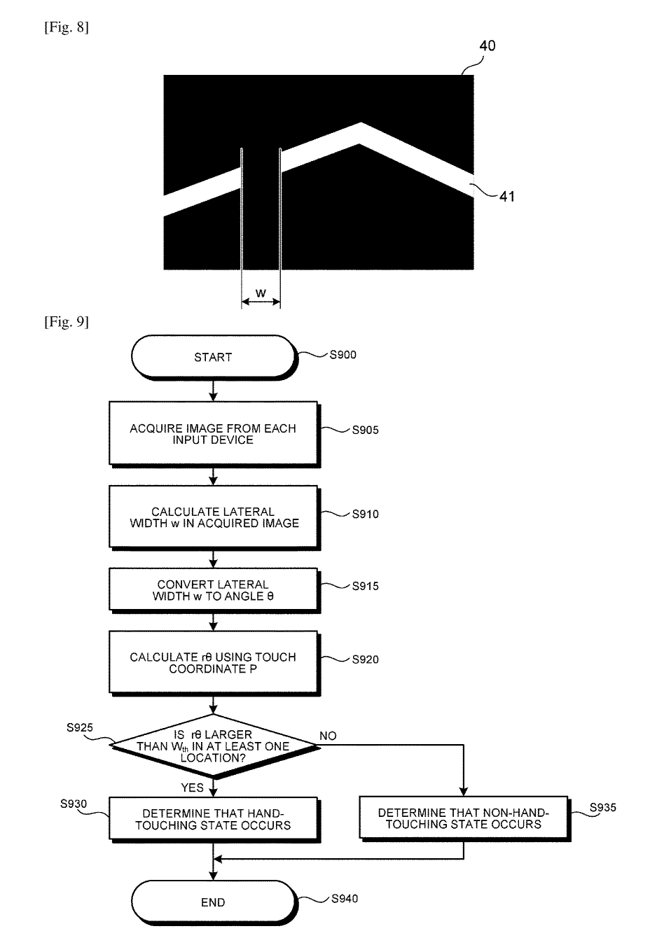

FIG. 8 is a view illustrating an example of a light-blocking image. An image 40 illustrated in FIG. 8 is an image as output information output from the input device 12. A belt-shaped part 41 that is continuously white illustrated in FIG. 8 represents light reflected by the retroreflection plate 14, and a part illustrated in black where the white belt-shaped part 41 is interrupted in the middle, in other words, a blocking part represents a lateral width w of the contact object 11. The lateral width w can be calculated by counting the number of pixels forming the image 40.

The following describes processing for determining whether the hand-touching state occurs in detail with reference to FIG. 9. This processing starts from Step 900, and at Step 905, the image 40 is acquired as output information output from each of the input devices 12. The image 40 is an image as illustrated in FIG. 8. The lateral width w of the blocking part is calculated from the acquired image 40 at Step 910. The calculated lateral width w is converted to the angle θ at Step 915. Correspondence information indicating the relation between the number of pixels and the angle θ is used for this conversion. A correspondence table can be used as correspondence information. In addition to the correspondence table, a conversion expression can also be used for the conversion.

The touch coordinate P is calculated by triangulation, and the distance r from each of the input devices 12 to the touch coordinate P is calculated using a position coordinate of each of the input devices 12 at Step 920. The calculated r is multiplied by the angle θ so as to calculate rθ. At Step 925, rθ is compared with a preset threshold Wₜₕ and it is determined whether rθ is larger than the threshold Wₜₕ. If rθ is larger than the threshold Wₜₕ, it is determined that the hand-touching state occurs at Step 930, and if rθ is smaller than the threshold Wₜₕ, it is determined that the hand-touching state does not occur (non-hand-touching state) at Step 935. The process goes to Step 940, and this processing ends.

A method for calculating rθ and comparing rθ with a threshold has higher detection accuracy of the hand-touching state as compared to a method for comparing the lateral width w in each of the acquired images 40 with a threshold. The lateral width w becomes larger as an object to be determined is closer to the input devices 12, and becomes smaller as the object to be determined is farther from the input devices 12. For this reason, when a small-sized finger is close to the input devices 12 and a large-sized palm is far from the input devices 12, the hand-touching state may be misidentified. By contrast, unless the actual size of an object to be determined is changed, rθ is independent of the distance from the input devices 12, and the hand-touching state cannot be misidentified.

When it is determined that the hand-touching state occurs, the contact object 11 is a palm, an elbow, or the like, drawing of information input by the contact is not performed, and operation corresponding to the gesture operations is not implemented. For drawing that has already been performed due to a palm, an elbow, or the like, drawing contents are erased based on the feature amount accumulated in the accumulating unit 31. In this manner, an application that performs drawing by contact can cancel erroneous drawing caused by the hand-touching state, and a wait for avoiding erroneous drawing caused by a hand-touching state can be eliminated.

Once it is determined that the hand-touching state occurs, it is regarded that the hand-touching state occurs until the contact ends, and a gesture operation or drawing due to contact is not performed. This processing can avoid the case where, when a palm, an elbow, or the like touches the screen and is released from the screen after a lapse of a predetermined time, the size of the palm, the elbow, or the like becomes smaller than a predetermined size, and the palm, the elbow, or the like is regarded as contact other than the hand-touching state, causing malfunction of gestures and occurrence of unintended drawing.

The present invention has been described as the information processing apparatus, the information input system, and the information processing method with the embodiments, but the present invention is not limited to the embodiments. The present invention can be modified within the scope where the skilled in the art could have conceived of such as other embodiments, addition, modification, and deletion, and any aspects are included in the scope of the present invention as long as actions and effects of the present invention are exerted. Thus, the present invention can provide a computer program for causing a computer to execute the information processing method, a recording medium in which the computer program is recorded, external equipment for providing the computer program via a network, and the like.

### REFERENCE SIGNS LIST

10 Display apparatus
11 Contact object
12 Input device
13 Light-blocking lighting
14 Retroreflection plate
15 Controller
16 PC
20 CPU
21 ROM
22 RAM
23 HDD
24 Input/output I/F
25 Communication I/F
26 Bus
30 Calculating unit
31 Accumulating unit
32 Tracking unit
33 Determining unit
34 Control unit
35 Contact object presence/absence determining unit
36 Contact object determining unit
37 Switching unit
40 Image
41 Part

### CITATION LIST

### Patent Literature

PTL 1: Japanese Laid-open Patent Publication No. 2004-199714

1-9. (canceled)

10. An information processing apparatus configured to cause information input by contact of a contact object with a screen of a display apparatus to be displayed on the display apparatus, the information processing apparatus comprising:
a calculating unit configured to calculate a feature amount representing a feature of the contact object using output information output from a plurality of position detectors configured to detect a position where the contact object contacts the screen;
an accumulating unit configured to accumulate at least one feature amount calculated by the calculating unit;
a tracking unit configured to track where the contact object contacts the screen based on the feature amount calculated by the calculating unit and the at least one feature amount accumulated in the accumulating unit;
a switching unit configured to switch a lighting device configured to irradiate the contact object between on and off to sequentially switch between a first detection mode in which the switching unit turns off the lighting device and the position detectors detect the position where the contact object contacts the screen based on light emitted from the contact object, and a second detection mode in which the switching unit turns on the lighting device and the position detectors detect the position where the contact object contacts the screen based on the contact object blocking light emitted from the lighting device;
a determining unit configured to determine whether to receive input by contact of the contact object based on whether the position detectors detect light emitted from the contact object in the first detection mode, the feature amount calculated by the calculating unit and the at least one feature amount accumulated in the accumulating unit; and
a control unit configured to control, when the determining unit determines not to receive input, input by contact of the contact object not to be received until the tracking unit finishes tracking where the contact object contacts the screen.

11. The information processing apparatus according to claim 10, further comprising a contact object presence/absence determining unit configured to determine whether the contact object contacting the screen is present based on the output information output from the plurality of position detectors.

12. The information processing apparatus according to claim 10, further comprising a contact object determining unit configured to determine a type of the contact object based on the feature amount calculated by the calculating unit.

13. The information processing apparatus according to claim 10, wherein the control unit refers to the at least one feature amount accumulated in the accumulating unit, and erases the information input by contact of the contact object and displayed on the display apparatus.

14. An information input system comprising:
the information processing apparatus according to claim 10;
the display apparatus configured to display information; and
the plurality of position detectors configured to detect the position where the contact object contacts a screen of the display apparatus.

15. The information input system according to claim 14, further comprising a lighting device configured to irradiate the contact object with light.

16. An information processing method for causing information input by contact of a contact object with a screen of a display apparatus to be displayed on the display apparatus, the information processing method comprising:
calculating a feature amount representing a feature of the contact object using output information output from a plurality of position detectors configured to detect a position where the contact object contacts the screen;
accumulating at least one calculated feature amount in an accumulating unit;
tracking where the contact object contacts the screen based on the calculated feature amount and the at least one feature amount accumulated in the accumulating unit;
switching a lighting device configured to irradiate the contact object between on and off to sequentially switch between a first detection mode in which the lighting device is turned off and the position where the contact object contacts the screen is detected based on light emitted from the contact object, and a second detection mode in which the lighting device is turned on and the position where the contact object contacts the screen is detected based on the contact object blocking light emitted from the lighting device;
determining whether to receive input by contact of the contact object based on whether light emitted from the contact object is detected in the first detection mode, the calculated feature amount and the at least one feature amount accumulated in the accumulating unit; and
controlling, when it is determined not to receive input, input by contact of the contact object not to be received until the tracking of where the contact object contacts the screen ends.

17. A computer program product comprising a non-transitory computer-readable medium containing an information processing program, the program causing a computer to perform processing that causes information input by contact of a contact object with a screen of a display apparatus to be displayed on the display apparatus, the program causing the computer to perform:
calculating a feature amount representing a feature of the contact object using output information output from a plurality of position detectors for detecting a position where the contact object contacts the screen;
accumulating at least one calculated feature amount in an accumulating unit;
tracking where the contact object contacts the screen based on the calculated feature amount and the at least one feature amount accumulated in the accumulating unit;
switching a lighting device configured to irradiate the contact object between on and off to sequentially switch between a first detection mode in which the lighting device is turned off and the position where the contact object contacts the screen is detected based on light emitted from the contact object, and a second detection mode in which the lighting device is turned on and the position where the contact object contacts the screen is detected based on the contact object blocking light emitted from the lighting device;
determining whether to receive input by contact of the contact object based on whether light emitted from the contact object is detected in the first detection mode, the calculated feature amount and the at least one feature amount accumulated in the accumulating unit; and
controlling, when it is determined not to receive input, input by contact of the contact object not to be received until the tracking of where the contact object contacts the screen ends.
